(19) United States
(12) Patent Application Publication
(10) Pub. No.: US 2005/0094670 A1
(43) Pub. Date: May 5, 2005

(54) Method for acquiring header compression context in user equipment for receiving packet data service

(75) Inventor: Soeng-Hun Kim, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/922,466

(22) Filed: Aug. 20, 2004

(30) Foreign Application Priority Data
Aug. 20, 2003 (KR) 2003-57702
Oct. 4, 2003 (KR) 2003-69044

(51) Int. Cl. H04J 3/18; H04Q 7/24; H04Q 7/00; H04L 12/26

(52) U.S. Cl. 370/477; 370/328; 370/338

(57) ABSTRACT

Disclosed is a method for acquiring a Header Compression (HC) context information in User Equipment (UE) to receive a packet data service from a mobile communication system. In the method, the UE receives packet data including a compressed header from a Radio Network Controller (RNC), and determines whether to request retransmission of all or part of the header compression context, based on the received packet data, and transmits the determined retransmission request to the RNC. The RNC retransmits all or part of the header compression context to the UE in response to the determined retransmission request.

### PRIORITY

This application claims priority to an application entitled “METHOD FOR ACQUIRING HEADER COMPRESSION CONTEXT IN USER EQUIPMENT FOR RECEIVING PACKET DATA SERVICE”, filed in the Korean Intellectual Property Office on Aug. 20, 2003 and assigned Serial No. 2003-57702, and an application entitled “METHOD FOR ACQUIRING HEADER COMPRESSION CONTEXT IN USER EQUIPMENT FOR RECEIVING PACKET DATA SERVICE”, filed in the Korean Intellectual Property Office on Oct. 4, 2003 and assigned Serial No. 2003-69044, the contents of each of which are incorporated herein by reference.

### BACKGROUND OF THE INVENTION

1. Field of the Invention

The present invention relates to a mobile communication system for providing a packet data service, and more particularly to a method for requesting retransmission of packet data received by user equipment when an error occurs in the received packet data.

2. Description of the Related Art

FIG. 1 is a schematic drawing showing the configuration of a Universal Mobile Terrestrial System (UMTS) as a general mobile communication system.

The UMTS includes a Core Network (CN) 100, a plurality of Radio Network Subsystems (RNSs) 110 and 120, and a User Equipment (UE) 130. Each of the RNSs 110 and 120 includes a Radio Network Controller (RNC) 111 and 112 and a plurality of Node Bs 113-116 (also referred to as “base stations”). For example, the RNS 110 includes an RNC 111 and Node Bs 113 and 115, and the RNS 120 includes an RNC 112 and Node Bs 114 and 116. The RNCs 111 and 112 are classified into a Serving RNC (SRNC), a Drift RNC (DRNC) and a Controlling RNC (CRNC) according to their operations. The SRNC is an RNC that manages information of each UE and handles data transmission between the UE and the CN 100. When data of a UE is transmitted to and is received from the SRNC of the UE via a different RNC, the different RNC is referred to as a DRNC of the UE. The CRNC is an RNC for controlling Node Bs. In the example of FIG. 1, if the RNC 111 manages information of the UE 130, the RNC 111 is an SRNC of the UE 130, and if the UE 130 moves and communicates data via the RNC 112, the RNC 112 is a DRNC of the UE 130. The RNC 111, which controls the Node B 113 in communication with the UE 130, is a CRNC of the Node B 113.

The RNC is connected with each Node B via an Iub interface and RNCs are connected with each other via an Iur interface. Although not shown in FIG. 1, the UE is connected with the (UTRAN) via a Uu interface. The RNC allocates radio resources to Node Bs managed by the RNC, and each of the Node Bs provides the allocated radio resources to the UE. The radio resources are provided on a cell-by-cell basis. A Node B provides its radio resources to a specific cell managed by the Node B. Each UE in the specific cell establishes a radio channel using the radio resources provided to the specific cell managed by the Node B, and receives and transmits data using the established radio channel. Since the UE recognizes only physical channels established on a cell-by-cell basis, it is meaningless and not necessary to distinguish the base station from the cell. Hereinafter, the terms “Node B” and “cell” will be used interchangeably.

A Broadcast/Multicast Service has been introduced to provide services from one data source to a number of UEs in order to support multicast multimedia communication. The broadcast/multicast service can be classified into a Cell Broadcast Service (CBS), which is a message-based service, and a Multimedia Broadcast/Multicast Service (MBMS) which supports multimedia formats such as real-time images and audio, still images and text data.

A network structure for providing MBMS services in a mobile communication system will now be described with reference to FIG. 2. FIG. 2 is a schematic diagram showing a conventional network structure for providing MBMS services in a mobile communication system.

In FIG. 2, a Broadcast/Multicast-Service Center (BM-SC) 210 is a source that provides MBMS data streams. The BM-SC 210 schedules and transfers MBMS data streams of an MBMS service to a transit network 220. The transit network 220 is connected between the BM-SC 210 and a Serving GPRS Support Node (SGSN) 230 to transfer the MBMS data streams received from the BM-SC 210 to the SGSN 230. The SGSN 230 may include a Gateway GPRS Support Node (GGSN) and an external network. In the following discussion, it is assumed that a number of UEs (for example, first, second and third UEs 261, 262 and 263 belonging to a first cell (Node B1) 260 and fourth and fifth UEs 271 and 272 belonging to a second cell (Node B2) 270 intend to receive an MBMS service at a specific time. The SGSN 230 receives the MBMS data streams from the transit network 220 and performs control operations associated with MBMS services for subscribers (i.e., UEs) that desire to receive the MBMS services. For example, the SGSN 230 manages MBMS service billing data of each subscriber and selectively transmits MBMS data to a specific Radio Network Controller (RNC) 240. The SGSN 230 also manages an SGSN service context for the MBMS service, and transfers the data stream of the MBMS service to the RNC 240. The RNC 240 controls and manages a number of Node Bs, and transfers data of an MBMS service to one of the Node Bs where a UE requests the MBMS service. The RNC 240 also controls a radio channel established for providing the MBMS service, and manages an RNC service context for the MBMS service with the data streams of the MBMS service received from the SGSN 230. As shown in FIG. 2, one radio channel is established between one Node B (for example, the Node B1 260) and UEs (for example, the first to third UEs 261 to 263) belonging to Node B1 to provide the MBMS service to the UEs. Although not shown in FIG. 2, a Home Location Register (HLR) is connected with the SGSN 230 to perform subscriber authentication for the MBMS service.

A Uu interface established between a UE and an RNC will now be described with reference to FIG. 3. The Iu, Iub or Uu interface is established for communication between nodes. Messages of the higher layer processed in the UTRAN can be mainly divided into a control signal (i.e., a control plane (C-Plane) signal 301) and user data (i.e., user plane (U-Plane) data 302). The C-Plane signal 301 and the U-Plane data 302 are messages of a Non Access Stratum (NAS). The NAS messages are not used for radio access between the UE and the UTRAN, and thus the UTRAN does not need to know the information of the NAS messages. Differently from the NAS messages, Access Stratum (AS) messages are directly used for radio access between the UE and the UTRAN. Specifically, the AS messages are data or control signals used under a Radio Resource Control (RRC) layer 311. The C-Plane signal 301 includes signals of the RRC layer 311, a Layer 2 Radio Link Control (L2/RLC) layer 341, a Layer 2 Medium Access Control (L2/MAC) layer 371 and a physical layer (L1) 391. The U-Plane signal 302 includes signals of a Layer 2 Packet Data Convergence Protocol (L2/PDCP) layer 321, and a Layer 2 Broadcast/Multicast Control (L2/BMC) layer 331, and the L2/RLC layer 341, the L2/MAC layer 371 and the physical layer 391. Each of the layers has the following functions.

The physical layer 391 performs channel coding/decoding, modulation/demodulation, channelization/dechannelization, etc., to convert data for transmission to a radio signal and convert a received radio signal to data. Through a suitable procedure, transport channels transferred to the physical layer 391 are mapped to actual physical channels and are then transmitted to the UE or RNC. The physical channels include a Primary Common Control Physical Channel (P-CCPCH) for transfer of a Broadcast Channel (BCH), a Secondary Common Control Physical Channel (S-CCPCH) for transfer of a Paging CHannel (PCH) and a Forward Access Channel (FACH), a Dedicated Physical Channel (DPCH) for transfer of a Dedicated Channel (DCH), a Physical Downlink Shared Channel (PDSCH) for transfer of a Downlink Shared Channel (DSCH), a High Speed Physical Downlink Shared Channel (HS-PDSCH) for transfer of an HS-DSCH and a Physical Random Access Channel (PRACH) for transfer of Random Access Channel (RACH). Pure physical channels other than the above physical channels, which do not carry higher layer data or control signals, include a Pilot Channel (PCH), a Primary Synchronization Channel (P-SCH), a Secondary Synchronization Channel (S-SCH), a Paging Indicator Channel (PICH), an Acquisition Indicator Channel (AICH) and a Physical Common Packet Channel (PCPCH). The physical layer 391 is connected with the L2/MAC layer 371 via a transport channel 381. Processing schemes and types in which specific data items are handled in the physical layer 391 are defined in the transport channel 381. The processing schemes and types include a channel coding scheme and a transport block set size which is the amount of data that can be transmitted in a unit of time. Table 1 describes the types and roles of the transport channels.

TABLE 1

| Transport | |
|---|---|
| Channels | Roles |
| Broadcast | Mapped to a BCCH to transmit data of the BCCH. |
| Channel | |
| (BCH) | |
| Paging | Mapped to a PCCH to transmit data of the PCCH. |
| Channel | |
| (PCH) | |
| Random | Used for transmission of network access and control |
| Access | messages and small-size data from a UE to the network. |
| Channel | |
| (RACH) | |
| Forward | Used for transmission of control messages and data from |
| Access | the network to a specific UE and a specific set of UEs, |
| Channel | and can be mapped to BCCH, CTCH, CCCH, DTCH |
| (FACH) | and DCCH. |
| Dedicated | Used for transmission of data and control signals between |
| Channel | the network and a UE, and mapped to DTCH and DCCH. |
| (DCH) | |
| Downlink | A downlink channel from the network to a UE, used for |
| Shared | high volume data transmission, and mapped to DTCH and |
| Channel | DCCH. |
| (DSCH) | |
| High Speed | A downlink channel from the network to a UE, which |
| DSCH | improves transmission efficiency of DSCH, and is |
| (HS-DSCH) | mapped to DTCH and DCCH. |

The L2/MAC layer 371 functions to transfer data, received from the RLC through a logical channel 361, to the physical layer 391 through the transport channel 381, and also to transfer data, received from the physical layer 391 through the transport channel 381, to the L2/RLC layer 341 through the logical channel 361. The L2/MAC layer 371 also functions to insert additional information into data received through the logical channel 361 or the transport channel 381 or to analyze the inserted additional information and perform a suitable operation based on the analysis. The logical channel 361 is mainly classified into a dedicated channel for a specific UE and a common channel for a number of UEs. The logical channel 361 is also classified into a control channel and a traffic channel according to its message type. Table 2 describes the types and roles of the logical channels.

TABLE 2

| Logical | |
|---|---|
| channels | Roles |
| Broadcast | Used for downlink transmission of UTRAN system |
| Control | control information from the UTRAN to a UE. |
| Channel | |
| (BCCH) | |
| Paging Control | Used for downlink transmission of control information |
| Channel | from the UTRAN to a UE when the location of a cell to |
| (PCCH) | which the UE belongs is not known. |
| Common | Used for transmission of control information between the |
| Control | network and a UE when the UE has no connection |
| Channel | channel with the RRC. |
| (CCCH) | |
| Dedicated | Used for point-to-point transmission of control |
| Control | information between the network and a UE when |
| Channel | the UE has a connection channel with the RRC. |
| (DCCH) | |
| Common | Used for point-to-multipoint data transmission |
| Traffic | between the network and UEs. |
| Channel | |
| (CTCH) | |
| Dedicated | Used for point-to-point data transmission |
| Traffic | between the network and a UE. |
| Channel | |
| (DTCH) | |

The L2/RLC layer 341 receives a control message destined for the UE from the RRC layer 311, and processes the received control message into a format suitable for characteristics of the message in RLC 351 and RLC 352. The processed control message is transmitted to the L2/MAC layer 371 through the logical channel 361. The L2/RLC layer 341 also receives data from the L2/PDCP layer 321 and the L2/BMC layer 331 and processes the received data into a suitable format in RLC 353 and RLC 354. The processed data is transmitted to the L2/MAC layer 371 through the logical channel 361. The number of RLCs in the L2/RLC layer 341 is determined based on the number of radio links existing between the UE and the RNC. The L2/RLC 341 operates in one of an Acknowledged Mode (AM), an Unacknowledged Mode (UM) and a Transparent Mode (TM). Different functions are provided in the modes. The RLCs 351 to 354 are RLC entities, each of which operates in one of the three modes.

The L2/PDCP layer 321, which is located above the L2/RLC layer 341, performs header compression of data received in the form of IP packets and prevents loss of data when the RNC is changed due to mobility of the UE. The L2/BMC layer 331, which is also located above the L2/RLC layer 341, supports broadcast services for transmitting the same data to unspecified UEs in a specific cell. The RRC layer 311 functions to allocate or release radio resources between the RNC and the UE. The 3GPP (third Generation Partnership Project) has a number of methods for supporting MBMS, which are primarily divided into two modes (i.e., connected and idle modes) according to the relationship between the UE and the RNC. The term “connected mode” refers to a state in which the RRC layer 311 can perform control signaling or data exchange with a specific UE as described with reference to FIG. 3 and the RRC layer 311 has information of the specific UE. An RRC connection is required in the connected mode. Using the RRC connection, the RNC transfers information regarding radio resources allocated to UEs, information of mobility of the UEs, and CN signals destined for the UEs to the corresponding UE. The term “idle mode” refers to a state in which the RRC layer 311 has no information of existence of a specific UE, and the RRC 311 and the specific UE have no way to perform control signaling or data exchange with each other.

A description will now be given of the operation of nodes supporting MBMS services. FIG. 4 is a process flow diagram showing the procedure for providing an MBMS service from an RNC to UEs desiring to receive the MBMS service. The RNC provides the MBMS service to UEs, which desire to receive the MBMS service, via a Node B (not shown). MBMS control messages transmitted for the MBMS service will also be described in the following.

In FIG. 4, the UE desires to receive the MBMS service and the RNC provides the MBMS service to the UE. As described below, four procedures (i.e., announcement, joining, paging, and Radio Bearer (RB) setup procedures) are sequentially performed to provide the MBMS service. In the announcement procedure of step 400, the SGSN informs the UE of when the MBMS service is to be started. The information for the announcement includes information of which MBMS services are to be started, information of the time to start the MBMS services, and information of the duration of the MBMS services.

Upon receipt of the announcement of MBMS services from the SGSN, a UE desiring to receive an MBMS service performs a joining procedure with the SGSN at step 410. In the joining procedure, the UE transmits a joining request message to the SGSN. The joining request message includes an ID code of a specific MBMS desired by the UE from among a list of MBMS services transmitted from the SGSN, and an ID of the UE desiring to receive the specific MBMS service. At step 410, the SGSN performs authentication of a UE requesting an MBMS service and notifies the UE of whether the UE can receive the MBMS service. At step 410, the SGSN also stores a list of UEs desiring to receive the specific MBMS service and locations of the UEs.

After completing the joining procedure of the MBMS service, the mobile communication system performs a paging procedure (steps 415 to 430). If the BM-SC informs the SGSN of the start of the MBMS service, the SGSN transmits, at step 415, a session start message to RNCs where the UEs, which have completed the joining procedure, are located.

To page UEs intending to receive the MBMS service, the RNC transmits, at step 420, a paging message through a common channel such as a Secondary-Common Control Physical Channel (S-CCPCH). The paging is a process to notify the UEs desiring the MBMS service that the MBMS service will be started. Since the paging message is transmitted to page a plurality of UEs, the procedure of step 420 is referred to as “group paging”, as compared to the conventional paging. The notification message (i.e., the group paging message) can be transmitted through an MBMS Control Channel (MCCH).

At step 430, the paged UEs transmit an MBMS paging response message to the RNC in response to the paging message. Using the response message received from the UEs, the RNC can determine the number of UEs desiring to receive the MBMS service in each cell to determine the radio channel type of each cell. When a large number of UEs in a cell desire to receive an MBMS service, the MBMS service is provided through a common channel. When a small number of UEs in a cell desire to receive an MBMS service, the MBMS service is provided through a dedicated channel established for each UE.

After performing the paging-related procedure, the UE desiring to receive the MBMS service performs a Radio Bearer (RB) setup procedure using RB information transmitted from the RNC through the MCCH at step 435. The RB setup procedure is a procedure to allocate radio resources for providing the MBMS service and to provide the allocation information to related UEs. In the RB setup procedure, MBMS RB information is transmitted to allow the UEs to receive the MBMS service using the MBMS RB information without an error. For example, the MBMS RB information includes radio channel information such as Orthogonal Variable Spreading Factor (OVSF) code information, transmission format information, Radio Link Control (RLC) information, and Packet Data Convergence Protocol (PDCP) information. Details of the MBMS RB information are described in the 3GPP TS 26.331 standard. After the RB setup procedure is completed, all UEs desiring to receive an MBMS service obtain information of a radio link for transmission of the MBMS service and information of a higher layer where the MBMS service is to be handled.

The MCCH is a channel for carrying MBMS-related control information. Characteristics of the MCCH are under discussion and have not yet been completely defined. According to the discussion as of the present time, the MCCH is expected to have the following features.

1. One MCCH is established for each cell.

2. The MCCH is transmitted through a common physical channel such as an S-CCPCH; and

3. UEs can obtain, as system information, information of an MCCH established for each cell.

At step 440, the RNC provides the MBMS service through the MBMS RB, and the UEs receive the MBMS service through the MBMS RB.

While the MBMS data is provided, the UEs receiving the MBMS service may move, making it necessary to change the channel type established between the RNC and the UEs. For example, when a large number of UEs located in a cell receive the MBMS service, the RNC provides, at step 440, the MBMS service to the UEs through a common channel (also referred to as a Point to Multipoint (PTM) channel). When the UEs move to another cell at a specific time, it is undesirable that the RNC provide the MBMS service through the PTM channel. That is, if there are a large number of UEs receiving the MBMS service in a specific cell, it is desirable that the MBMS service is provided to the UEs through the PTM channel. However, if there are a small number of UEs receiving the MBMS service in the specific cell, it is desirable that the MBMS service is provided to each of the UEs through a Point to Point (PTP) channel.

At step 450, the RNC determines if it is necessary to change the channel type for providing the MBMS service. Based on this determination, the RNC exchanges a specific control signal with the UEs located in the cell, and then establishes a dedicated transmission channel (i.e., a PTP channel) for each of the UEs. At step 460, the RNC provides the MBMS service using the established transmission channel.

Here, it is assumed that the MBMS data is transmitted and received between the RNC and each UE through a PTM channel at step 440, and through a PTP channel at step 460. However, the same can also be applied when the MBMS data is transmitted and received between the RNC and each UE through a PTP channel at step 440, and through a PTM channel at step 460.

It is expected that the MBMS data will be provided in the form of IP/UDP/RTP (Internet ProtocoWser Datagram Protocol/Real-Time Transport Protocol) packets, and a multimedia streaming service will be the most important MBMS application service. The use of IP/UDP/RTP is the most effective way to provide the multimedia streaming service. Since the size of an IP/UDP/RTP packet is 40 or 60 bytes, it is not efficient to transmit the IP/UDP/RTP packet without alteration in the radio link. For this reason, header compression and decompression is performed in the PDCP entity as described above with reference to FIG. 3, so that the header is compressed into several bytes and transmitted via the Uu interface. A header compression technique called “Robust Header Compression (ROHC)” will be used for the MBMS service, so that the PDCP entities of the RNC and the UE, which handle the MBMS data, must be provided with an ROHC header compressor and an ROHC header decompressor, respectively.

If the MBMS data transmission is started at step 440, the RNC compresses the MBMS data received from the SGSN using the ROHC compression technique and then transmits the compressed MBMS data to the UE. The UE decompresses the compressed MBMS data using the ROHC decompression technique. Even when the PTM channel is switched to the PTP channel, the PDCP is responsible for the header compression and decompression. The header compression and decompression will now be described in detail.

FIG. 5 illustrates general header compression and decompression. Upon receipt of an uncompressed header packet from the higher layer, a header compressor 510 compresses the packet according to a predetermined protocol and transmits the compressed packet to a decompressor 525. The compressed packet contains a Context ID (CID) indicating data and a protocol used to compress the packet. The header decompressor 525 decompresses the header using the CID of the received packet, and transfers the decompressed header to the higher layer. According to this header compression technique, only the compressed headers are received and transmitted in an actual transmission line, thereby achieving efficient utilization of transmission resources.

Header Compression (HC) contexts 515, 516, 530 and 531 each contain data relating to header compression/decompression, and have a CID as a unique ID. Packets having the same traffic characteristics are referred to as a packet stream. Packets included in the same packet stream are compressed/decompressed using the same HC context since the packets have the same source IP address, destination IP address, source port number and destination port number. Upon receipt of an uncompressed packet 505 from the higher layer, the header compressor 510 determines an HC context for a packet stream corresponding to the received packet, based on an IP address and a port number of the received packet. Alternatively, by tracing a path through which the packet 505 is received from the higher layer, the header compressor 510 determines to which packet stream the packet 505 belongs, and which HC context to use. Header information of a previously compressed packet and other necessary parameters are stored in the HC context. The packet header is composed of various types of fields, which can be classified according to their characteristics as follows.

1. Fields not Varying While a Call is in Progress

Fields of source IP address, destination IP address, source port number, destination port number, etc.

2. Fields Varying Regularly While a Call is in Progress

Fields of RTP Sequence Number (SN), etc.

3. Fields Varying Irregularly While a Call is in Progress

Fields of IP ID, Time To Live (TTL), etc.

The characteristics of each field are not always the same, and may be changed as circumstances demand. A detailed description of the changes of the characteristics will be omitted because it is unrelated to the present invention. The header compressor 510 compresses only values of the fields varying while the call is in progress, other than the fields not varying while the call is in progress, in the following manner. For the values of the fields varying regularly while the call is in progress, only the difference (also referred to as “delta”) between the current and previous values thereof is incorporated into the compressed header. The values of the fields varying irregularly while the call is in progress are incorporated, without alteration, into the compressed header. The header compressor 510 completes the header compression by inserting the CID into the compressed header, and transmits the compressed header packet to the header decompressor 525 provided in the UE.

Using a CID of the received packet 520, the header decompressor 525 determines which HC context to use in header decompression, and decompresses the header according to the determined HC context. For the fields not varying while the call is in progress, the corresponding field values in the HC context are inserted, without alteration, into the header. For the fields varying regularly while the call is in progress, the sums of the delta values and the corresponding field values in the HC context are inserted into the header. For the fields varying irregularly while the call is in progress, the received field values are inserted into the header. The header is decompressed in this manner, and the decompressed header packets 535 are transferred to the higher layer.

To perform the header compression/decompression as described above, the header compressor and decompressor must have the same HC context. Before the header compression/decompression, the header compressor 510 and decompressor 525 initialize their HC contexts to synchronize the HC contexts. To initialize the HC contexts, the header compressor 510 generally transmits all field values and CIDs to the header decompressor 525 at least twice, and the header decompressor stores the CIDs and field values received from the header compressor. A conventional HC context initialization method will now be described with reference to FIG. 6.

FIG. 6 illustrates how an RNC provides an MBMS service to a UE using a header compression scheme employing a U-mode of the Robust Header Compression (ROHC) in a mobile communication system. In the U-mode of the ROHC, the header compressor transmits an Initialization and Refresh (IR) packet to the header decompressor in the UE at least twice before transmitting compressed data. The header decompressor performs HC initialization using the IR packet received from the compressor. The procedure for providing the MBMS service from the RNC to the UE will now be described in detail with reference to FIG. 6.

At step 615, an SGSN transmits a Session Start (SS) message to the RNC. At step 620, the RNC transmits an MBMS paging message to page UEs desiring to receive the MBMS service. The paging message can be transmitted through an MBMS Control Channel (MCCH).

At step 630, the UEs transmit an MBMS paging response message in response to the paging message. The RNC determines the number of UEs desiring to receive the MBMS service in a corresponding cell to determine a radio channel type of the cell. For example, when a large number of UEs in a cell desire to receive an MBMS service, the MBMS service is provided to the cell through a common channel. When a small number of UEs in a cell desire to receive an MBMS service, the MBMS service is provided to the cell through a dedicated channel established for each UE. At step 635, the RNC transmits the determined radio bearer information through an MCCH to set up a Radio Bearer.

The Radio Bearer (RB) setup procedure is a procedure to allocate radio resources for providing the MBMS service and to provide the allocation information to related devices. If the RB is set up, it indicates that a PDCP entity for handling the MBMS service is formed in each of the RNC and the UE. In other words, the completed RB setup indicates that the same elements as those of the ROHC header compressor in the RNC have been formed in the ROHC header decompressor in the UE.

At step 637, the SGSN transfers MBMS data to the RNC. The MBMS data includes IP/UDP/RTP header and payload. At step 640, the RNC transmits an IR packet to the UE through a multicast traffic channel (MTCH). The IR packet has variable and invariable fields. Using the IR packet received from the RNC, the header decompressor in the UE can decompress the header of MBMS data received from the RNC at a later time.

At step 650, the RNC transmits the same IR packet as that transmitted at step 640 to the UE. At steps 640 and 650, the RNC transmits the IR packet to the UE before transmitting MBMS data received from the SGSN to the UE. Here, the RNC repeatedly transmits the IR packet to the UE at least twice to increase IR packet transmission efficiency. Since the IR packet is uncompressed, the header compression ratio decreases as the number of IR packet transmissions increases. On the contrary, if the number of IR packet transmissions decreases, the number of UEs successful in the HC initialization decreases but the header compression ratio increases. The number of IR packet transmissions in the HC initialization procedure can be determined, for example, based on the number of UEs that will receive the MBMS service in the corresponding cell.

As described above, in the HC initialization procedure of step 665, the RNC transmits an IR packet stored in the ROHC header compressor before transmitting the MBMS data, and the UE stores the IR packet received from the RNC in the ROHC header decompressor.

During the HC initialization procedure of step 665, the SGSN constantly transmits MBMS data to the RNC, and the RNC stores the MBMS data received from the SGSN until the HC initialization procedure is completed. At step 655, the ROHC header compressor in the RNC compresses an IR/UDP/RTP header of the MBMS data received from the SGSN, and transmits the MBMS data to the UE through a Multicast Traffic Channel (MTCH). At step 655, the UE decompresses the compressed IR/UDP/RTP header (cmp hdr) transmitted from the RNC through the MTCH to receive the MBMS data. At step 660, the RNC repeats the procedure of step 655. The header compressor in the RNC retransmits the IR packet at intervals of a predetermined period to refresh the HC contexts stored in the header decompressor in the UE. The predetermined period, at intervals of which IR packets are retransmitted, is referred to as an IR packet refresh period (680). The IR packet refresh period 680 is not set to a fixed value as with the number of IR packets transmitted in the HC initialization procedure, and the IR packet refresh period must be determined appropriately according to the circumstances.

The ROHC header compressor in the RNC activates a timer of the IR packet refresh period 680 at a time when the HC initialization procedure is completed, and transmits the IR packet at a time when the timer expires (675). At step 675, the IR packet can be transmitted at least twice in the same manner as in the HC initialization procedure.

As described above, the RNC repeats transmission of the same IR packet so that the UEs can properly receive the IR packet. However, the IR packet retransmission alone cannot guarantee the success of the HC initialization of all UEs that desire to receive the MBMS service. For example, if a specific UE is in a deep fading condition during the HC initialization, the UE cannot receive the IR packet without an error even when the RNC repeats the IR packet transmission.

In addition, if a specific UE, as a new subscriber, joins the MBMS service provided by the cell while the HC initialization is in progress, then the specific UE receives data packets with compressed headers without receiving the IR packet since the specific UE has not been subjected to the HC initialization procedure. In this case, the specific UE can receive and decompress the MBMS data only after waiting for the IR packet refresh period and then receiving the IR packet retransmitted from the RNC.

In other words, when operating in the U-mode of the ROHC, UEs cannot receive and decompress the MBMS data for a long time if they fail to obtain the HC context information in the HC initialization procedure.

### SUMMARY OF THE INVENTION

Therefore, the present invention has been made in view of the above problems, and it is an object of the present invention to provide a method for requesting, by a UE, retransmission of HC context information from an RNC when the UE fails to decompress a compressed header of packet data received from the RNC.

It is another object of the present invention to provide a method for requesting retransmission of only HC context information items, which have been unsuccessfully decompressed, from among the total HC context information items, thereby reducing the amount of transmitted and received data.

It is yet another object of the present invention to provide a method for transmitting HC context information from the RNC through different paths or means according to the number of UEs that have requested retransmission of the HC context information.

In accordance with one aspect of the present invention, the above and other objects can be accomplished by the provision of a method for decompressing a header of packet data received by User Equipment (UE) in a mobile communication system providing a packet data service, the method including receiving, by the UE, packet data including a compressed header from a Radio Network Controller (RNC); determining, by the UE, whether to request retransmission of all or part of header compression context information, based on the received packet data, and transmitting the determined retransmission request from the UE to the RNC; and retransmitting said all or part of the header compression context information from the RNC to the UE in response to the determined retransmission request.

In accordance with another aspect of the present invention, there is provided a method for decompressing a header of packet data received by a UE in a mobile communication system providing a packet data service, the method including receiving, by the UE, packet data including a compressed header from an RNC; determining, by the UE, whether to request retransmission of all or part of header compression context information, based on the received packet data, and transmitting the determined retransmission request from the UE to the RNC through an RRC message; and retransmitting said all or part of the header compression context information from the RNC to the UE through a dedicated data channel for packet data transmission in response to the determined retransmission request.

In accordance with yet another aspect of the present invention, there is provided a method for decompressing a header of packet data received by a UE in a mobile communication system providing a packet data service, the method including if an error occurs in decompressing the header of the received packet data, requesting, by the UE, retransmission of part or all of header compression context information depending on a cause of the error; and decompressing, by the UE, a header of the received packet data using header compression context information received in response to the retransmission request.

In accordance with a further aspect of the present invention, there is provided a method for transmitting header compression context information for use in compression of a packet data header from an RNC in a mobile communication system providing a packet data service, the method including receiving, by the RNC, a request for retransmission of all or part of header compression context information according to a cause of an error occurring in header decompression, said request being received from a UE; checking, by the RNC, whether header compression context information corresponding to the retransmission request received from the UE is stored in the RNC; and determining, by the RNC, whether to transmit all or part of the checked header compression context information according to the retransmission request received from the UE, and transmitting said all or part of the header compression context information according to the determination.

In accordance with another aspect of the present invention, there is provided a method for transmitting header compression context information for use in compression of a packet data header to a UE, which has requested a packet data service being provided by a mobile communication system, the method including checking header compression context information of packet data being provided to a cell where the UE is located; and transmitting the checked header compression context to the UE.

In accordance with yet another aspect of the present invention, there is provided a method for receiving, by a UE, header compression context information for use in compression of a packet data header, said UE having requested a current packet data service being provided by a mobile communication system, the method including requesting the current packet data service from a Core Network (CN) by the UE; notifying, by the CN, a Radio Network Controller (RNC) corresponding to a cell, where the UE is located, of the service request by the UE; and, checking, by the RNC, header compression context information for packet data being provided to the cell where the UE is located, and transmitting the checked header compression context to the UE by incorporating the checked header compression context into information required to set up a radio bearer.

### BRIEF DESCRIPTION OF THE DRAWINGS

The above and other objects, features and other advantages of the present invention will be more clearly understood from the following detailed description taken in conjunction with the accompanying drawings, in which:

FIG. 1 illustrates the configuration of a general mobile communication system;

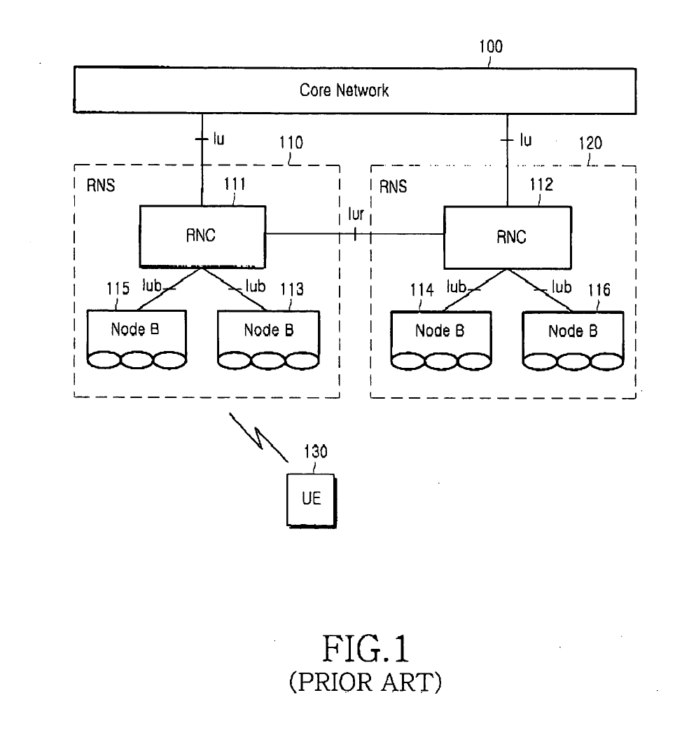

FIG. 2 illustrates the structure of a Uu interface between a Radio Network Controller (RNC) and User Equipment (UE);

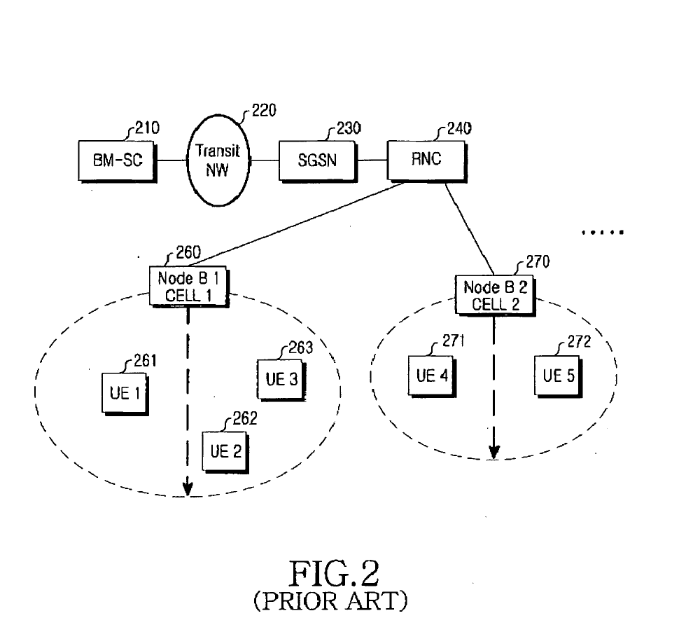

FIG. 3 illustrates the configuration of a conventional Multimedia Broadcast/Multicast Service (MBMS) system;

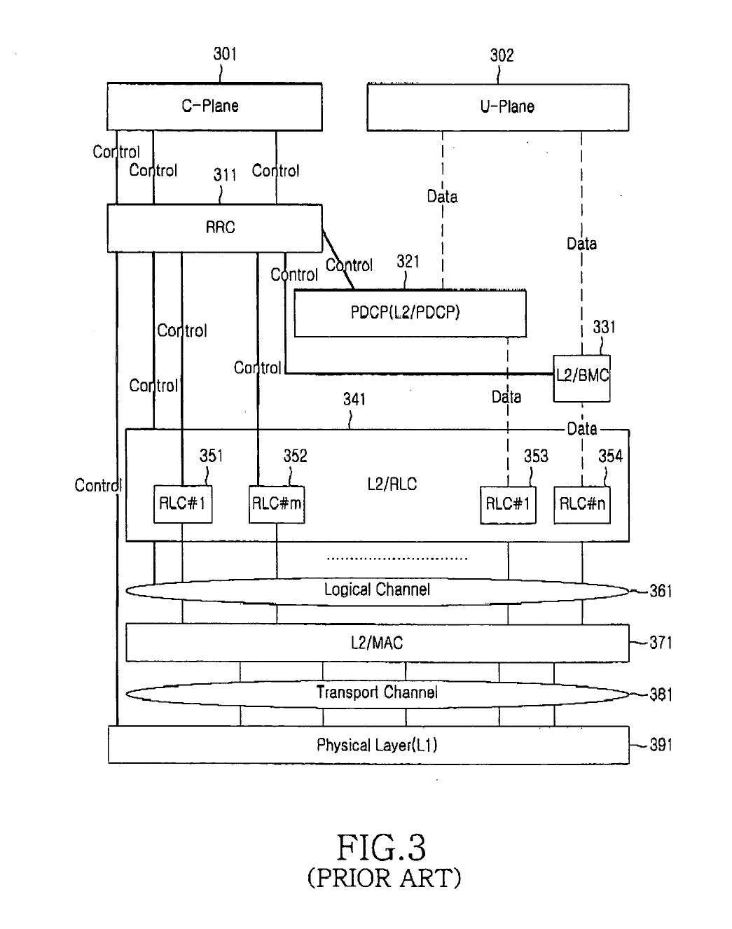

FIG. 4 is a process flow diagram illustrating the operation of the nodes of a mobile communication system for providing an MBMS service;

FIG. 5 illustrates how the RNC compresses a header of MBMS packet data and the UE decompresses the compressed header;

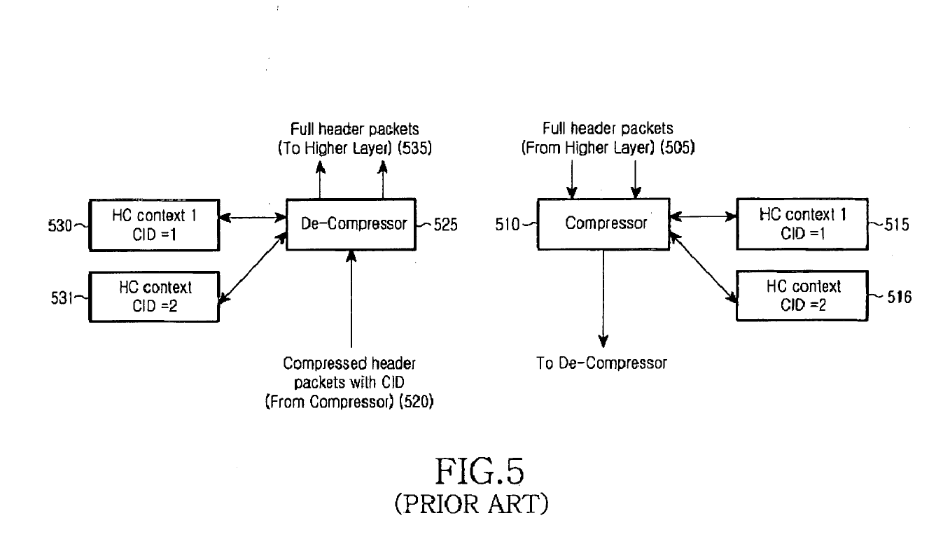

FIG. 6 is a process flow diagram illustrating how the mobile communication system operates to provide an MBMS service using Header Compression (HC) context information.

FIG. 7 illustrates the structure of an HC context for use in header compression/decompression;

FIG. 8 is a process flow diagram illustrating how the UE requests retransmission of HS context information and the RNC retransmits the HS context information;

FIG. 9 is a flow chart illustrating how a Packet Data Convergence Protocol (PDCP) entity in a UE operates to receive the MBMS service according to a first embodiment of the present invention;

FIG. 10 is a flow chart illustrating how a Radio Resource Control (RRC) entity in the UE operates to receive the MBMS service according to the first embodiment of the present invention;

FIG. 11 is a flow chart illustrating how an RRC entity in an RNC operates to receive the MBMS service according to the first embodiment of the present invention;

FIG. 12 is a flow chart illustrating how a PDCP entity in the RNC operates to receive the MBMS service according to the first embodiment of the present invention;

FIG. 13 is a process flow diagram illustrating how a UE requests retransmission of HC context information and an RNC retransmits the HC context information according to a second embodiment of the present invention;

FIG. 14 is a process flow diagram illustrating a problem occurring when a UE joins the MBMS service in progress;

FIG. 15 is a process flow diagram illustrating one embodiment of an IR packet transmission method for overcoming the problem of FIG. 14;

FIG. 16 is a flow chart illustrating how an RNC operates according to the IR packet transmission method of FIG. 15;

FIG. 17 is a process flow diagram illustrating another embodiment of the IR packet transmission method for overcoming the problem of FIG. 14; and

FIG. 18 is a process flow diagram illustrating yet another embodiment of the IR packet transmission method for overcoming the problem of FIG. 14.

### DETAILED DESCRIPTION OF THE PREFERRED EMBODIMENTS

Now, preferred embodiments of the present invention will be described in detail with reference to the annexed drawings. In the following description, a detailed description of known functions and configurations incorporated herein will be omitted when it may make the subject matter of the present invention unclear.

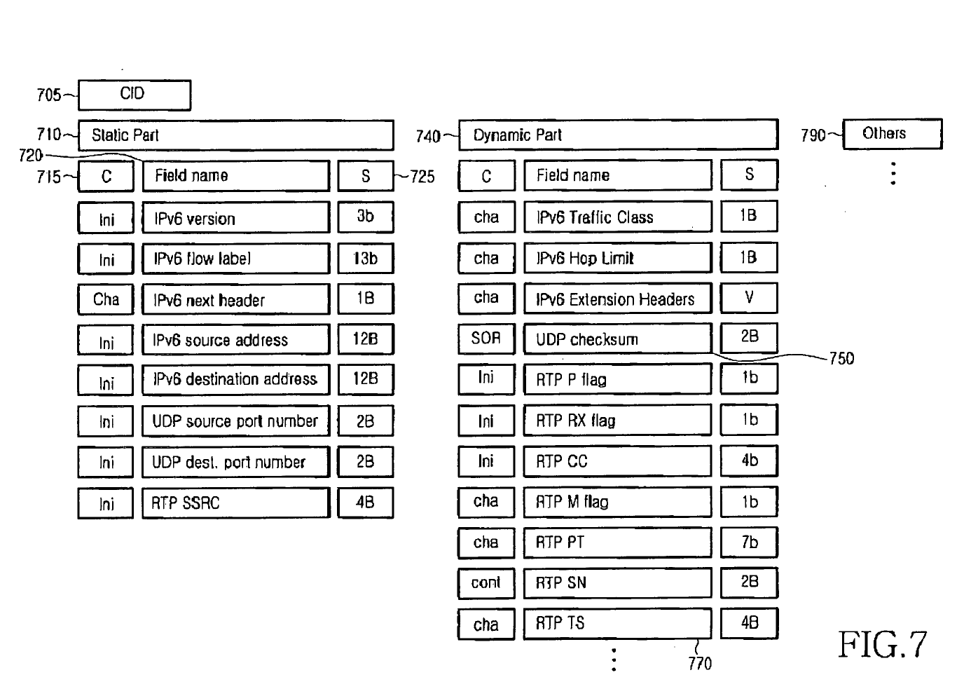

FIG. 7 illustrates the structure of an HC context used in the ROHC when the ROHC technique is applied to Internet Protocol version 6, (IPv6), UDP(User Datagram Protocol), and RTP(Realtime Transport Protocol). The HC context structure varies depending on a header compression technique to be used and the type of a header to be compressed. As described above, the HC context contains data and parameters to be used by the header compressor and decompressor for header compression and decompression. The HC context structure of FIG. 7 is common to both the header compressor and decompressor. It is apparent that the header compressor and decompressor can further include elements other than those shown in FIG. 7. The header compressor and decompressor may differ slightly but the difference will not be described since it is unrelated to the present invention.

A plurality of contexts stored in the header compressor/decompressor are distinguished from each other by their Context IDs (CIDs) 705. Each of the contexts has a unique CID. The HC context mainly includes a static part 710, a dynamic part 740 and other parameters part 790. Each of the parts stores header values and configuration parameters classified according to their types. As shown in FIG. 7, each part is divided into a field characteristic (C) 715, a field size (S) 725 and a field name 720 representing a corresponding field type. The field size 725 is expressed in bits “b” or Bytes “B”. When the field size 725 is variable, it is represented by “V”. The field name 720 is composed of the name of a corresponding field and the name of a protocol to which the corresponding field belongs. For example, a field name “IPv6 version” is composed of a protocol name “IPV6” and a field name “version”. The field characteristic 715 is designated as follows:

Ini: To indicate a field which always has the same value while a corresponding packet stream exists and thus is not transmitted after being transmitted from the header compressor to the header decompressor during the context initialization procedure.

Cha: To indicate a field which has a variable value and is thus transmitted each time the field value is changed.

Cont: To indicate a field which has a regularly varying value (for example, a monotonically increasing value) and is thus transmitted in all packets.

SOR: To indicate a field which is always transmitted or never is transmitted according to the packet stream type, for example, a UDP checksum field 750 which is always transmitted in a packet stream using the UDP checksum, and is not transmitted at all in a packet stream not using the UDP checksum.

Header field values, which are constant while a corresponding packet stream exists, are stored in the static part 710. Therefore, the characteristics of field values stored in the static part 710 are mostly “Ini”. The characteristics of each field will be described only when necessary.

Header field values, which are variable while a corresponding packet stream exists, are stored in the dynamic part 740. For example, an “IPv6 Traffic Class” field indicates the order of priority and a processing scheme in which a corresponding packet payload is to be processed in each router, and has a constant value in a single packet stream. However, the “IPv6 Traffic Class” field value is included in the dynamic part since the possibility of a change in the header field value cannot be ruled out. The “IPv6 Hop Limit” field indicates the number of routers through which a corresponding packet has passed up to the current time. Since the value of the “IPv6 Hop Limit” field is changed each time the transmission path is changed, the value thereof is included in the dynamic part.

HC context configuration parameters, etc., are stored in the other parameters part 790. For example, information of an HC context operating mode or information of whether a mode is switched is stored in the other parameters part 790.

The IR packet includes a CID (i.e., an identifier of the HC context) and static and dynamic part information. The header decompressor constitutes an HC context as shown in FIG. 7, based on the information included in the IR packet.

Using the HC context, the header compressor compresses a header of a packet received from the higher layer, and transmits the packet after inserting a CID into the compressed header. The header compressor uses different compression schemes depending on the characteristics of each field as described above with reference to FIG. 7. In detail, the header compressor operates in the following manner.

1. Remove an “Ini” field (i.e., a field having the “Ini” field characteristic) from the header of a packet received from the higher layer.

2. Compress a field value of a “Cha” field of the header of the packet received from the higher layer when the field value differs from that stored in the HC context, and remove the field value of the “Cha” field from the packet when the field value is identical to that stored in the HC context.

3. Transmit only Least Significant Bits (LSBs), required for correct field value estimation, of a “Cont” field of the header of the packet received from the higher layer. The technique for transmitting only the required LSBs, instead of the total field bits, is referred to as “Window based Least Significant Bit (W-LSB)”.

4. Update the HC context with header field values of the packet received from the higher layer, and store the updated header field values.

5. Transmit the compressed header, a CID and a payload to the header decompressor.

The header decompressor recovers the CID, the compressed header and the payload received from the header compressor. In detail, the header decompressor operates in the following manner.

1. Select one of the stored HC contexts using the CID of the received packet.

2. Add a corresponding field value stored in the HC context to an “Ini” header field of the received packet.

3. Update the HC context with a “Cha” field value of the header of the received packet if the received packet includes the “Cha” field, and add a “Cha” field value stored in the HC context to the header if the received packet does not include the “Cha” field.

4. Replace an RTP Sequence Number (RTP SN) value stored in the HC context with a corresponding value determined based on LSBs included in a received head field.

5. Determine a corresponding RTP TS based on the RTP SN.

6. Transfer the decompressed header with a corresponding payload to the higher layer, and update the HC context.

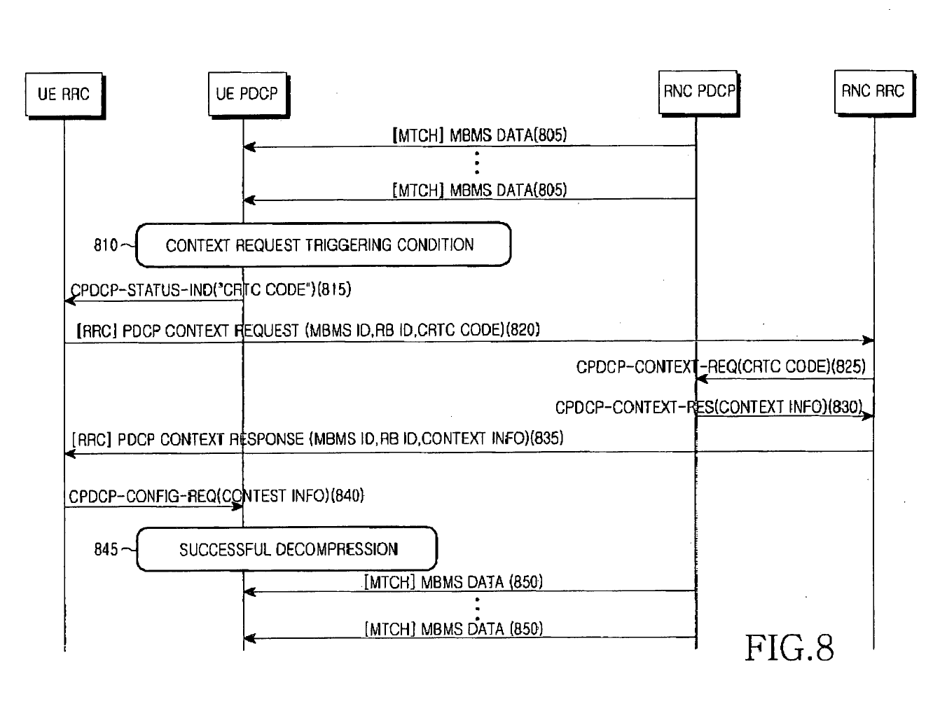

A method for operating the UE and the RNC according to the present invention will now be described in detail with reference to FIG. 8.

FIG. 8 illustrates how the PDCP transmits feedback information generated from the header decompressor in the UE to the header compressor in the RNC through an RRC connection in an MBMS service environment for ROHC U-mode operation, according to the present invention. The condition in which the feedback information must be transmitted is hereinafter referred to as a “Context Request Triggering Condition (CRTC)”. The following is a description of the CRTC.

The CRTC indicates a condition in which the feedback information (i.e., information requesting retransmission of HC contexts) is to be transmitted from the header compressor in the UE to the header compressor in the RNC. The following are examples of the CRTC.

CRTC 1: A condition in which the header decompressor in the UE must request all of the HC context information from the header compressor in the RNC.

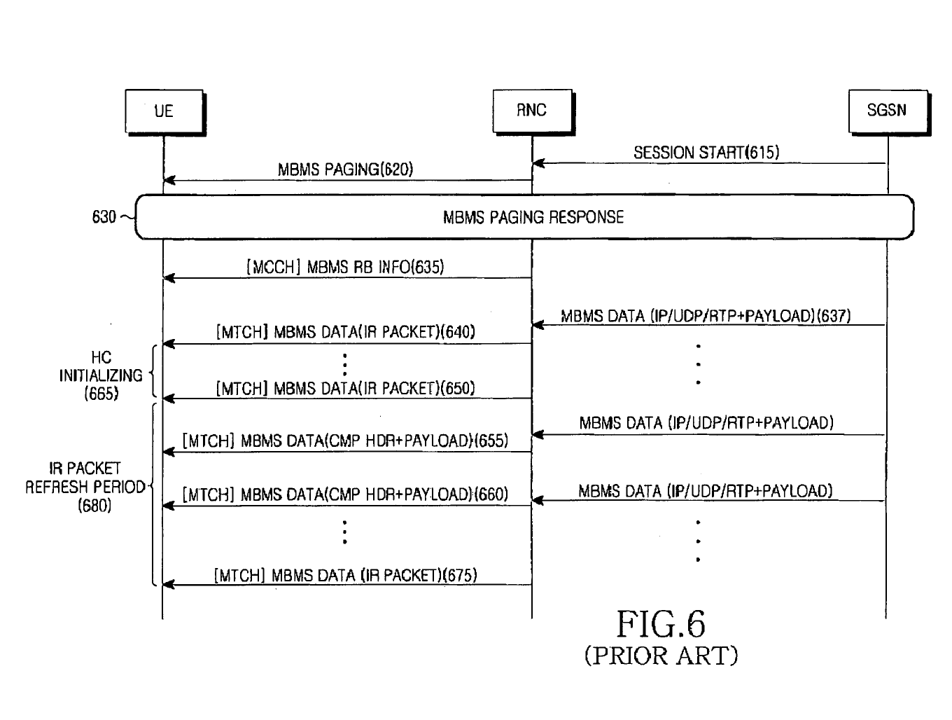

It is determined that the CRTC 1 is satisfied in the event that the UE receives a packet having a compressed header in a state (referred to as “a no-context state”) where no HC context has been constituted in the header decompressor in the UE. For example, referring back to FIG. 6, it is considered that the CRTC 1 is satisfied when the UE receives a header-compressed packet at step 655 in the case where the UE has not received any one of the IR packets transmitted during the HC initialization procedure and the UE is still in the no-context state upon completion of the HC initialization procedure.

CRTC 2: A condition in which the header decompressor in the UE needs to request part of the HC context from the header compressor in the RNC.

It is determined that the CRTC 2 is satisfied in the event that the header decompressor performs a header decompression procedure not in the no-context state and that n attempts of the k header decompression attempts by the header decompressor are unsuccessful. The values n and k are configuration parameters set when the header decompressor is constituted.

When the events satisfying the CRTC 1 or CRTC 2 occur, the header decompressor in the UE notifies the header compressor in the RNC of the condition CRTC 1 or CRTC 2 of the UE through the RRC connection. Based on the notified CRTC type, the header compressor determines which information is to be transferred to the header decompressor.

In the mobile communication system supporting the MBMS, the header compressor is constituted in a PDCP entity in the RNC, and the header decompressor is constituted in a PDCP entity in the UE. The PDCP entities are created using the MTCH in the MBMS RB setup procedure.

In FIG. 8, at step 805, the header compressor in the RNC transmits MBMS data to the header decompressor in the UE several times through the MTCH. The MBMS data may be compressed data if the HC initialization has already been performed, and may be an IR packet if the HC initialization is in progress.

At step 810, the PDCP entity in the UE (referred to as a “UE PDCP” for simplicity) determines whether an event satisfying the CRTC occurs. The UE PDCP sets a CRTC code indicating the CRTC 1 (for example, corresponding to the event that the header decompressor provided in the UE PDCP receives a packet other than the IR packet in the no-context state) or the CRTC 2 (for example, corresponding to the event that n of the k header decompression attempts are unsuccessful). At step 815, the UE PDCP transfers a CPDCP-STATUS-IND message including the set CRTC code to the UE RRC (i.e., the RRC layer in the UE). If an event satisfying the CRTC 1 occurs, the UE PDCP transfers a CPDCP-STATUS-IND message including a CRTC code corresponding to the CRTC 1 to the UE RRC. On the other hand, if an event satisfying the CRTC 2 occurs, the UE PDCP additionally transfers an RTP sequence number (LATEST RTP SN) of a header that has been successfully decompressed most recently and a corresponding Context ID (CID) to the UE RRC.

At step 820, the RRC layer in the UE transfers a PDCP context request, associated with the event occurrence of the CRTC 1 or CRTC 2, to the RRC layer in the RNC (hereinafter also referred to as “RNC RRC”) through an RRC message. If the UE is in idle mode at this time, the UE first performs RRC connection establishment before transmitting the PDCP context request. The PDCP context request message includes at least the following information items:
MBMS ID: The identifier of an MBMS service, which is the same as the MBMS ID used in the MBMS RB setup procedure;
RB ID: The identifier of an RB for providing the MBMS service, which is the same as the RB ID used in the MBMS RB setup procedure; and
CRTC code: CRTC code information of the CPDCP-STATUS-IND message.

The MBMS and RB IDs correspond to a PDCP entity in the RNC that handles corresponding MTCH data. When a PDCP entity is constituted in the MBMS RB setup procedure of an MBMS service, the PDCP entity is identified by MBMS and RB IDs used in the MBMS RB setup procedure.

At step 825, the RNC RRC identifies a PDCP using the MBMS and RB IDs included in the received PDCP context request message, and transfers a CPDCP context request message (CPDCP-CONTEXT-REQ) including the CRTC code to the identified PDCP entity.

At step 825, based on the CRTC code in the CPDCP context request message received from the RRC layer, the RNC PDCP determines context information (CONTEXT INFO), which is HC-related information to be transmitted to the header decompressor in the UE, of the HC-related information managed in the header compressor in the RNC PDCP.

At step 830, in response to the CPDCP context request message (CPDCP-CONTEXT-REQ), the RNC PDCP transfers a CPDCP context response message (CPDCP-CONTEXT-RES) including the context information (CONTEXT INFO) to the RNC RRC.

At step 835, the RNC RRC transfers a PDCP context response message (PDCP-CONTEXT-RES) to the UE RRC through an RRC message. The PDCP context response message includes at least the following information items; and
MBMS ID: The identifier of an MBMS service, which is the same as the MBMS ID used in the PDCP context request message;
RB ID: The identifier of an RB for providing the MBMS service, which is the same as the RB ID used in the PDCP context request message; and
CONTEXT INFO: the context information in the message “CPDCP-CONTEXT-RES” of step 830.

At step 840, the UE RRC transfers the context response message including the context information (CONTEXT INFO) to the UE PDCP. The UE PDCP updates the stored HC context with the context information received from the UE RRC.

If the HC context is updated at step 840 in response to the CRTC event occurrence of step 810, the UE PDCP normally performs header decompression at step 845. In response to the event occurrence of the CRTC 1, the UE PDCP receives a header and parameters corresponding to all of the HC context. In response to the event occurrence of the CRTC 2, the UE PDCP receives a header and parameters corresponding to a required part of the HC context.

At step 850, the UE PDCP receives MBMS data transmitted from the RNC PDCP to perform header decompression.

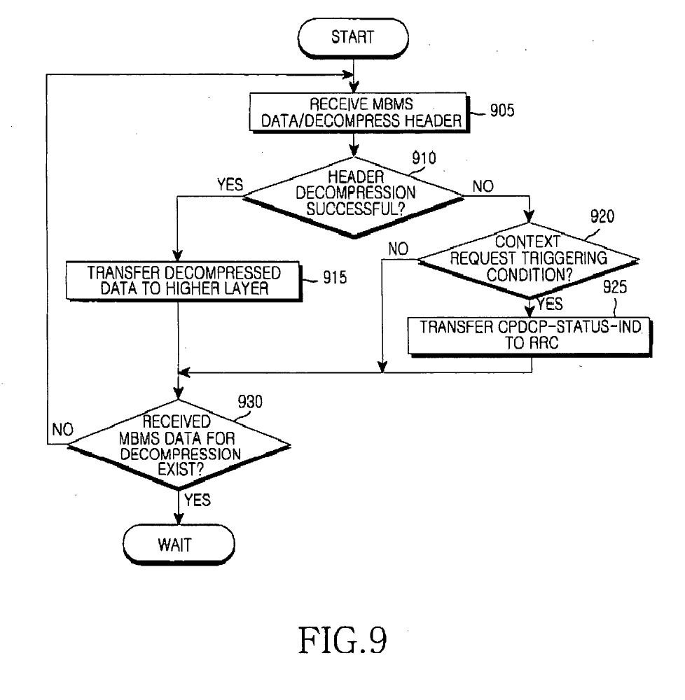

FIG. 9 is a flow chart showing how the UE PDCP operates according to the present invention. The UE PDCP serves to set up an MBMS RB, and decompress a header of data received through an MTCH.

As shown in FIG. 9, at step 905, the UE PDCP receives MBMS data through an MTCH. At step 910, the UE PDCP attempts to decompress a header of the received MBMS data using HC contexts stored in the header decompressor. If the decompression attempt is successful, the UE PDCP moves to step 915, and if unsuccessful, it moves to step 920.

At step 915, the UE PDCP transfers the successfully decompressed header and data to the higher layer and then moves to step 930. At step 920, the UE PDCP discards the unsuccessfully decompressed header and data, and checks a CRTC code indicating the reason why the header decompression failed. That is, the UE PDCP checks whether or not the header decompression failure reason corresponds to the CTRC 1 or CTRC 2. If the failure reason corresponds to the CTRC 1 or CTRC 2, the UE PDCP moves to step 925, otherwise it moves to step 930.

At step 925, the UE PDCP transfers a CPDCP-STATUS-IND message including the decompression failure reason (i.e., information of the CTRC 1 or CTRC 2) to the UE RRC.

At step 930, the UE PDCP checks whether there is packet data to be subjected to header decompression. If the packet data to be subjected to header decompression exists, the UE PDCP moves to step 905, otherwise the UF PDCP waits until another packet data is received.

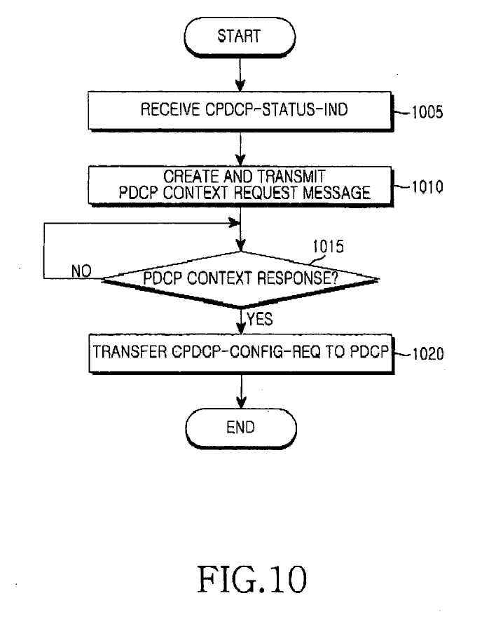

Although only the operation of the UE PDCP for transmitting the message to the UE RRC is shown in FIG. 9, the UE PDCP also operates to update the HC context information in the header decompressor with the HC context information received from the RNC. Specifically, if the UE PDCP receives a CPDCP-CONFIG-RES message including HC context information requested by the UE PDCP, the UE PDCP updates the HC context information stored in the header decompressor using the received HC context information. FIG. 10 is a flow chart showing in detail how the UE RRC operates according to the present invention.

As shown in FIG. 10, at step 1005, the UE RRC receives a CPDCP-STATUS-IND message, including a CTRC code indicating the header decompression failure reason, from the UE PDCP, and checks the ID of the PDCP entity in the UE PDCP. The PDCP entity ID corresponds to RB and MBMS IDs corresponding to an MTCH to which the UE PDCP entity belongs.

At step 1010, the UE RRC creates and transmits a PDCP context request message to the RNC RRC. The PDCP context request message includes the CRTC code and the MBMS and RB IDs checked at step 1005. If the UE is in RRC idle mode at this time, the UE RRC first performs RRC connection establishment with the RNC RRC before transmitting the PDCP context request message. The RRC connection establishment is implemented by setting up a Signaling Radio Bearer (SRB) between the UE and the RNC. The SRB is an RB set up for transmitting and receiving the RRC message between the UE and the RNC.

After transmitting the PDCP context request message, the UE RRC determines, at step 1015, whether a PDCP context response message is received. If a PDCP context response message is received, the UE RRC moves to step 1020, otherwise it returns to step 1015 to wait until a PDCP context response message is received.

At step 1020, using MBMS and RB IDs in the PDCP context response message, the UE RRC identifies a PDCP entity to which corresponding context information (CONTEXT INFO) is to be transferred, and transfers a CPDCP-CONFIG-REQ message including the context information to the identified PDCP entity.

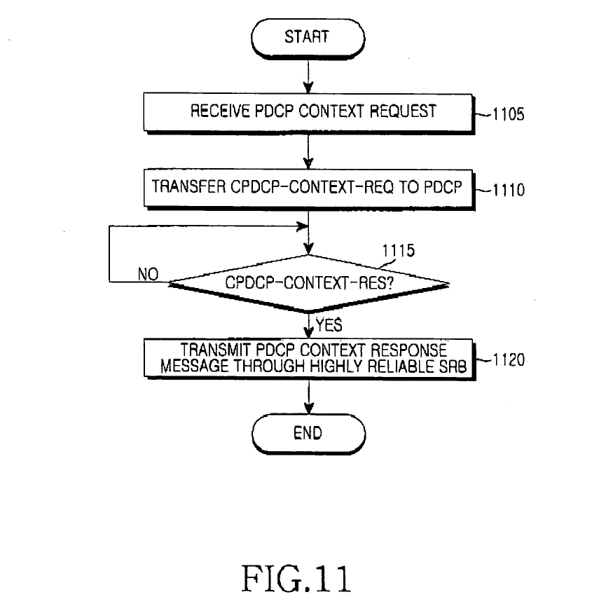

FIG. 11 is a flow chart showing how the RNC RRC operates according to the present invention.

As shown in FIG. 11, at step 1105, the RNC RRC receives a PDCP context request message transmitted from the UE RRC, and identifies a corresponding RNC PDCP entity using MBMS and RB IDs in the received message. At step 1110, the RNC RRC transfers a CPDCP context request message including CRTC code information to the identified RNC PDCP entity. At step 1115, the RNC RRC checks whether a CPDCP context response message is received from the RNC PDCP in response to the CPDCP context request message. If a CPDCP context response message is received, the RNC RRC moves to step 1120, otherwise it returns to step 1115 to wait until a CPDCP context response message is received.

At step 1120, the RNC RRC inserts context information (CONTEXT INFO) in the received CPDCP context response message received from the RNC PDCP into a PDCP context response message, and transmits the PDCP context response message to the UE RRC through an SRB.

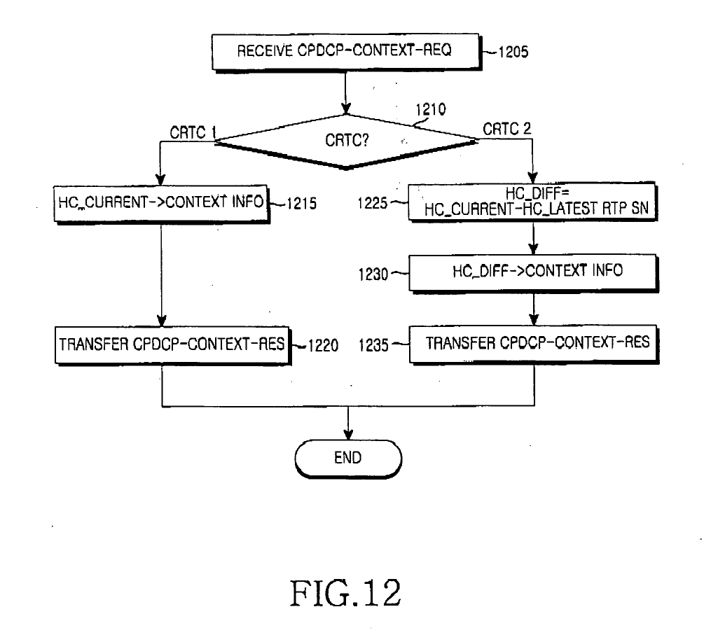

FIG. 12 is a flow chart showing how the RNC PDCP operates according to the present invention.

As shown in FIG. 12, at step 1205, the RNC PDCP receives a CPDCP context request message including context information from the RNC RRC. At step 1210, the RNC PDCP checks CRTC code information included in the received CPDCP context request message. If the CRTC code information corresponds to the CRTC 1, the RNC PDCP moves to step 1215, and if the information corresponds to the CRTC 2, the RNC PDCP moves to step 1225.

At step 1215, the RNC PDCP inserts HC context values used most recently (HC_current) into a corresponding context information (CONTEXT INFO) parameter. At step 1220, the RNC PDCP transmits the context information parameter to the RNC RRC through a CPDCP context response message, and then terminates the procedure.

The RNC PDCP manages an HC context set per CID, and the HC context set is composed as follows:
An HC context set for a specific CID={HC_current, HC_RTP SN x, HC_RTP SN x-1, . . . }

Here, “HC_current” indicates the latest HC context value, and “HC_RTP SN x” indicates an HC when the RTP SN is “x”. When circumstances permit (for example when there is enough storage space), the RNC PDCP stores not only the latest HC context values “HC_current” but also the past HC context values “HC_RNT SN x”. The past HC context values are used in constituting a response primitive for the CRTC 2.

At step 1225, the RNC PDCP calculates the HC context difference values “HC_diff” corresponding to the CID. As described above, the RNC PDCP has one HC context set per CID, and uses information included in the one HC context set to calculate the HC context difference values “HC_diff”. The HC context difference values “HC_diff” is a set of values corresponding to differences between the latest RNC HC context values “HC_current” and the latest UE HC context values “HC_LATEST RTP SN” included in the CRTC code information corresponding to the CRTC 2. The latest UE HC context values “HC_LATEST RTP SN” are HC context values corresponding to an RTP SN of a packet successfully decompressed most recently by the header decompressor in the UE. To compensate for the differences between the HC context values of the header decompressor in the UE and the latest HC context values “HC_current” in the header compressor in the RNC, it is necessary to notify the header decompressor of the values corresponding to the differences between the latest RNC HC context values “HC_current” and the latest UE HC context values “HC_LATEST RTP SN”. If the latest UE HC context values “HC_LATEST RTP SN” is not available to the header compressor, the header compressor regards the HC context difference values “HC_diff” as the entirety of the dynamic part of the latest RNC HC context value “HC_current”.

At step 1230, the RNC PDCP inserts the HC context difference values “HC_diff” calculated at step 1225 into the context information. At step 1235, the RNC PDCP inserts the context information into a CPDCP context response message and transfers the message to the RNC RRC, and then terminates the procedure.

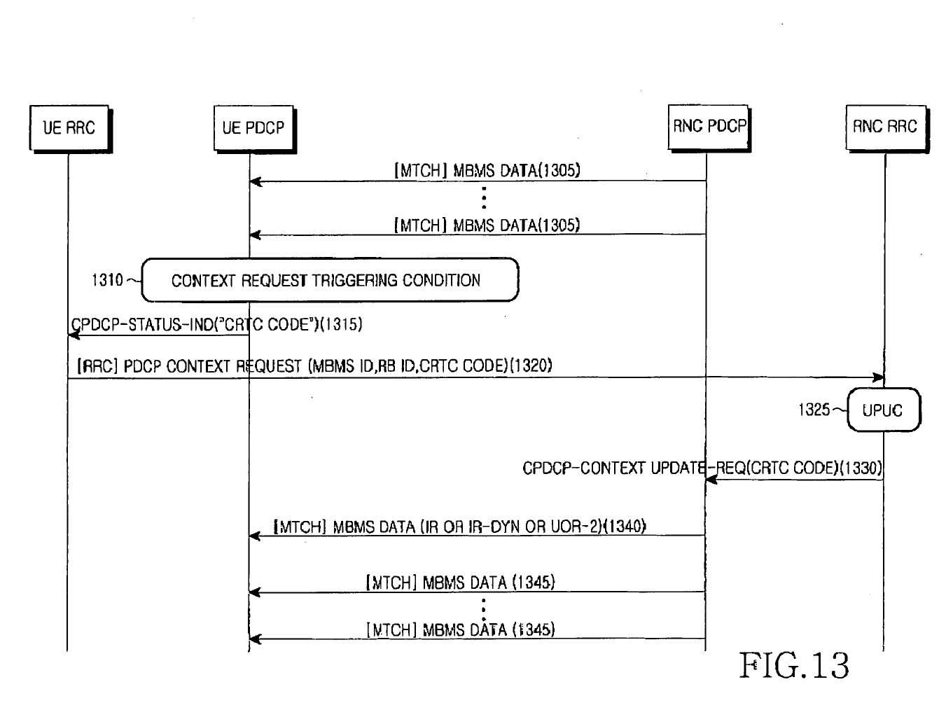

As described above with reference to FIGS. 8 to 12, the UE and the RNC use an RRC message to transmit the HC context information associated with header decompression. If a small number of UEs have requested the HC context information, the RRC message is effective in point-to-point transmission of the HC context information. However, if a large number of UEs have requested the HC context information, it is inefficient to individually transmit the RRC message to the UEs. FIG. 13 is a process flow diagram showing a method for transmitting the HC context information from the RNC through an MTCH, instead of the RRC message, when a large number of UEs have requested the HC context information, and illustrates how the UE requests IR packet retransmission from the RNC according to the present invention. The procedure of steps 1305 to 1320 of FIG. 13 is identical to the procedure of steps 805 to 820 of FIG. 8.

At step 1325, the RNC RRC determines whether it uses the RRC message or the user plane (specifically, an MTCH established in the user plane) for HC context information update. At step 1325, if a User Plane Update Triggering Condition (UPUC) is satisfied, the RNC RRC uses the user plane to transfer the HC context information, otherwise it uses the RRC message to transfer the HC context information.

The RRC, PDCP or other entities may perform determination of whether the UPUC is satisfied. In FIG. 13, it is assumed that the RRC entity determines whether the UPUC is satisfied. The UPUC satisfaction determination is based on the number of UEs, which have requested the HC context information during a predetermined time interval, among UEs located in the same cell. Two parameters (i.e., a time period T_{—}1 and a triggering point) are required for the UPUC satisfaction determination. The time period T_{—}1, which is the period of a T_{—}1 timer, is a time required for the UPUC satisfaction determination, and the triggering point indicates the number of PDCP context request messages transmitted from UEs located in the same cell, which is required to satisfy the UPUC.

The UPUC satisfaction determination is performed on a cell-by-cell basis in the following manner. That is, the operation of the T_{—}1 timer and the number of PDCP context requests are associated with a single cell.

UPUC Satisfaction Determination Algorithm

1. After transmitting HC context information of a specific cell, the RNC RRC activates the T_{—}1 timer upon receipt of a first PDCP context request, and sets a request counter to 1.

2. The RNC RRC increases the value of the request counter by one each time it receives a PDCP context request transmitted from another UE located in the same cell.

3. If the request counter reaches a value greater than or equal to the triggering point before the T_{—}1 timer expires, the RNC RRC determines that the UPUC is satisfied.

4. If the request counter still has a value less than the triggering point when the T_{—}1 timer expires, the RNC RRC determines that the UPUC is not satisfied.

If the determination of step 1325 is that the UPUC is not satisfied, the RNC RRC uses the RRC message to transmit the HC context information to the UE as in the procedure of FIG. 8. If the UPUC is satisfied, the RNC RRC uses an MTCH established in the user plane to transmit the HC context information to the corresponding UEs as shown in FIG. 13. At step 1330, the RNC RRC transfers a CPDCP context update request (CPDCP-CONTEXT UPDATE-REQ) primitive to the RNC PDCP. If RNC PDCPs corresponding to the MTCH are formed respectively for cells, the RNC RRC transfers the HC context information to an RNC PDCP responsible for a specific cell to which the HC context information is to be transmitted. If only one PDCP is formed in the RNC, the CPDCP context update request primitive includes a cell ID identifying the specific cell to which the HC context information is to be transmitted. Due to the CPDCP context update request primitive, MBMS data containing the HC context information is transmitted through the MTCH. In this case, the MBMS data containing the HC context information must be transmitted only to the cells satisfying the UPUC.

The CPDCP context update request primitive contains CRTC code information. Determination as to which CRTC code information is to be inserted into the CPDCP context update request primitive is performed in the following manner. At step 1320, the UPUC is satisfied only when a larger number of UEs than the triggering point in the same cell each transmit PDCP context request messages, which contain CRTC codes. A set of the CRTC codes is referred to as a CRTC code set.

1. Check whether a CRTC code corresponding to the CRTC 2 exists in the CRTC code set.

2. Move to “4” if the CRTC code corresponding to the CRTC 2 exists, otherwise move to “3”.

3. Insert CRTC code information indicating the CRTC 1 into CPDCP-CONTEXT UPDATE-REQ.

4. Insert a CRTC code indicating the CRTC 2 and the latest RTP SN into CPDCP-CONTEXT UPDATE-REQ. The latest RTP SN is the smallest RTP SN in the CRTC code set.

At step 1340, the RNC PDCP transmits an IR packet, an IR-DYN packet, or a UOR-2 packet. In detail, the transmission of step 1340 is performed in the following manner. If the CRTC code received at step 1330 corresponds to the CRTC 1, the RNC PDCP transmits an IR packet through an MTCH. The IR packet includes all of the static, dynamic and other parts of the HC context shown in FIG. 7. If the CRTC code received at step 1330 corresponds to the CRTC 2 and the RNC PDCP has the latest UE HC context values “HC_LATEST RTP SN”, the RNC PDCP calculates the HC context difference values “HC_diff”. The calculated difference values “HC_diff” are transmitted using a UOR-2 packet that contains only required elements of the dynamic part in an extension field. Flags corresponding respectively to the elements of the dynamic part are present in the extension field of the UOR-2 packet. The flags indicate whether the respective elements exist. Using the UOR-2 packet, the header compressor in the RNC can selectively transmit desired HC context information items to be updated. If the CRTC code received at step 1330 corresponds to the CRTC 2 and the RNC PDCP does not have the latest UE HC context values “HC_LATEST RTP SN”, the RNC PDCP transmits an IR-DYN packet, which contains only the dynamic part of the HC context shown in FIG. 7.

The transmission of the IR, IR-DYN or UOR-2 packets through the MTCH at step 1340 can be performed a number of times to increase the chance that the ULEs receive the packets. At step 1345, the RNC PDCP transmits MBMS data with a compressed header.

The failure of the UE to receive the HC context information due to a bad radio environment during the HC initialization procedure has been described above as an example of the event causing the HC initialization failure. However, the HC initialization failure may also be caused by a UE joining the MBMS service in progress.

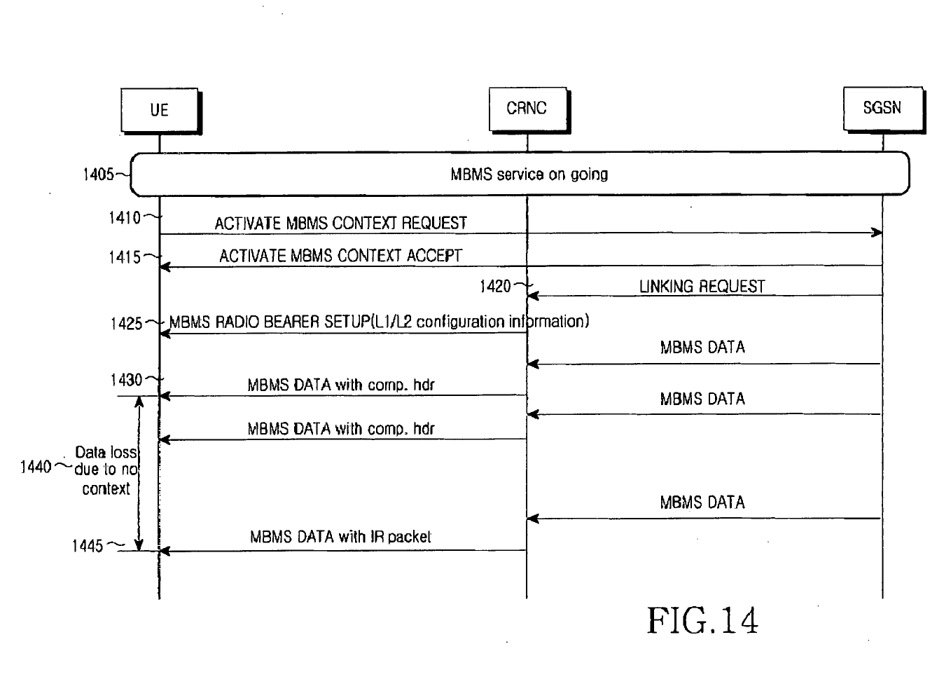

With reference to FIG. 14, a description will now be given of a problem caused when a UE attempts to join the service in progress. For convenience of explanation, it is assumed in the following description that an SRNC and a CRNC are the same entity.

As shown in FIG. 14, at step 1405, the UE is receiving the MBMS service from the CRNC. That is, the HC initialization procedure has already been completed, so that the CRNC compresses and transmits an MBMS data header, and UEs, which have requested the MBMS service, decompress the compressed MBMS data header to receive the MBMS service.

At step 1410, a specific UE transmits a message, with a request to join the MBMS service currently in progress, to the SGSN. At step 1415, the SGSN transmits an accept message in response to the joining request received from the UE.

After transmitting the accept message at step 1415, the SGSN notifies, at step 1420, CRNC (or SRNC), where the specific UE is located, that the UE desires to join the MBMS service. At step 1425, the CRNC transfers Layer 1 and Layer 2 information of the MBMS service, which is being provided in a cell where the UE is located, to the UE. The UE establishes a radio channel for receiving the MBMS service using the information received from the CRNC at step 1425, and receives the MBMS service using the established radio channel.

However, starting with step 1405, the CRNC uses a compressed header to provide the MBMS service. However, since the specific UE has not been notified of the compressed HC context information, the UE cannot decompress a compressed header received from the CRNC so that it cannot receive the MBMS service from the CRNC. That is, the UE cannot decompress a header of MBMS data received from the CRNC at step 1430. The UE must discard the received MBMS data (step 1440) until it receives an IR packet periodically transmitted from the CRNC (step 1445).

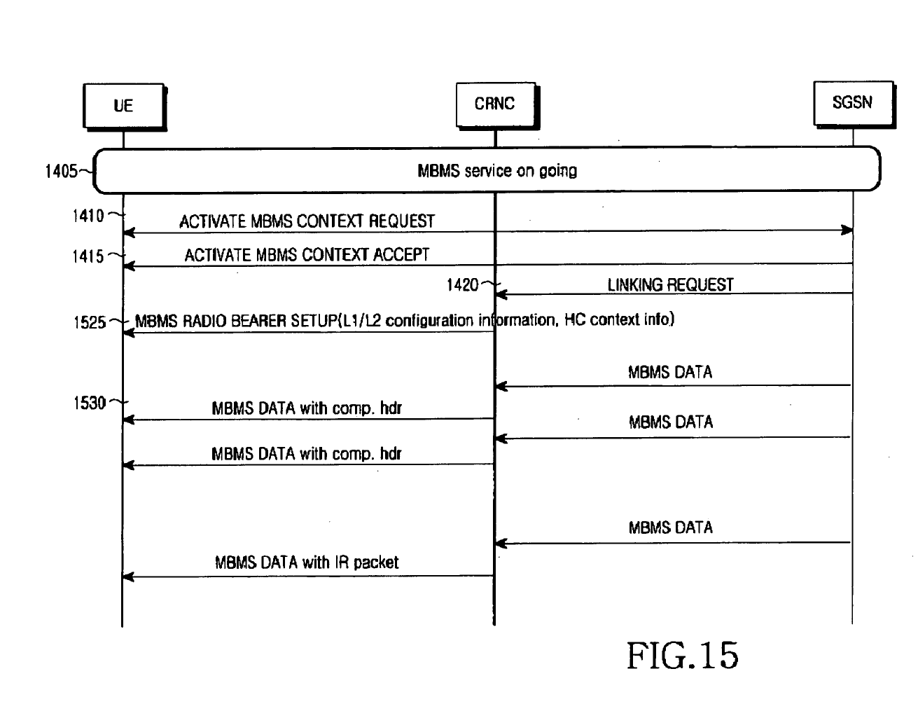

Thus, there is a need to provide an IR packet transmission method taking into consideration such a situation of FIG. 14. Embodiments of the IR packet transmission method will now be described with reference to FIGS. 15 to 18.

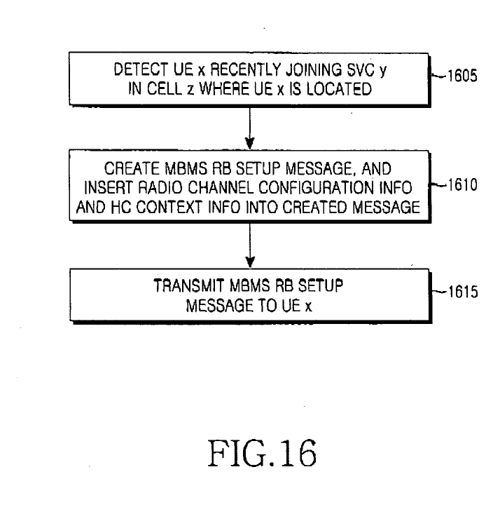

FIGS. 15 and 16 are diagrams showing one embodiment of the IR packet transmission method that is effective against situations as in FIG. 14.

Steps 1410 to 1420 of FIG. 15 are identical to the above steps 1410 to 1420 of FIG. 14, and a description thereof will thus be omitted.

When a CRNC detects that a specific UE has made a request to join an MBMS service in progress, the CRNC transmits, at step 1525, configuration information of a radio channel, through which the MBMS service is being provided, to the UE. The radio channel configuration information includes not only Layer 1 and Layer 2 information but also HC context information of the MBMS service in progress. The UE stores the HC context information received at step 1525. At step 1530, the UE receives MBMS data having a compressed header through the CRNC from the SGSN, and decompresses the received data using the stored HC context information.

In the embodiment of FIG. 15, before providing radio channel configuration information of an MBMS service to a UE, the CRNC first determines whether the MBMS service is in progress in a cell where the UE is located. If the determination is that the MBMS service is in progress in the cell, the CRNC incorporates HC context information into the radio channel configuration information to be transmitted to the UE.

Accordingly, even when the UE joins the MBMS service in progress, the UE can receive the HC context information through a PTM channel in the cell where the UE is located. If data of the MBMS service is being provided through a PTP channel in the cell where the UE is located, the UE can receive the HC context information through the PTP channel. FIG. 15 illustrates the case where, when the UE makes a request to join the MBMS service, the MBMS service is being provided through a PTM channel and the MBMS data transmission has already been started in the cell where the UE is located.

The operation of the CRNC in the embodiment of FIG. 15 will now be described with reference to FIG. 16.

As shown in FIG. 16, at step 1605, the CRNC detects that there is a specific UE (UE x) requesting to join a specific MBMS service (SVC y) in a specific cell (cell z) where the ULE is located. The purpose of detecting the existence of the UE (UE x) is to perform a service joining procedure between the SGSN and the UE (UE x) desiring to receive the MBMS service (SVC y). After performing the service joining procedure, the SGSN transmits a message, indicating that the UE has requested to join the MBMS service in progress, to the CRNC in charge of managing the cell where the UE is located. This message includes an MBMS ID of the specific MBMS service that the UE desires to receive. Upon receipt of this message, the CRNC checks a radio bearer condition of the requested MBMS service in the cell where the UE is located.

At step 1610, the CRNC produces an MBMS radio bearer setup message so that the specific UE (UE x) can receive the MBMS service in the cell (cell z). The MBMS radio bearer setup message includes radio channel configuration information, which includes PDCP, RLC, MAC and physical layer configuration parameters or information. The MBMS radio bearer setup message includes HC context information in addition to the configuration information.

At step 1615, the CRNC transmits the produced MBMS radio bearer setup message to the specific UE (UE x). Upon receipt of this message, the UE first constitutes a PDCP entity, an RLC entity, a MAC entity and a physical layer according to the PDCP, RLC, MAC and physical layer configuration information. The UE provides the HC context information to the constituted PDCP entity, and the PDCP entity constitutes an HC context using the HC context information. Using the constituted HC context, the UE decompresses MBMS data with a compressed header received from the CRNC.

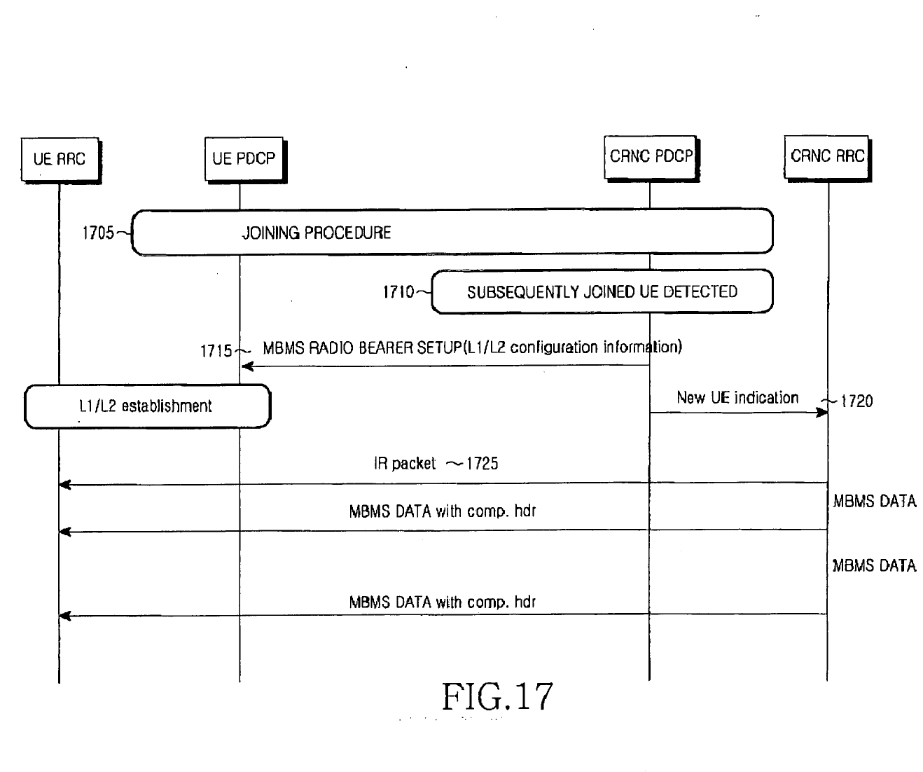

FIG. 17 is a process flow diagram showing another embodiment of the IR packet transmission method that is effective against situations as in FIG. 14.

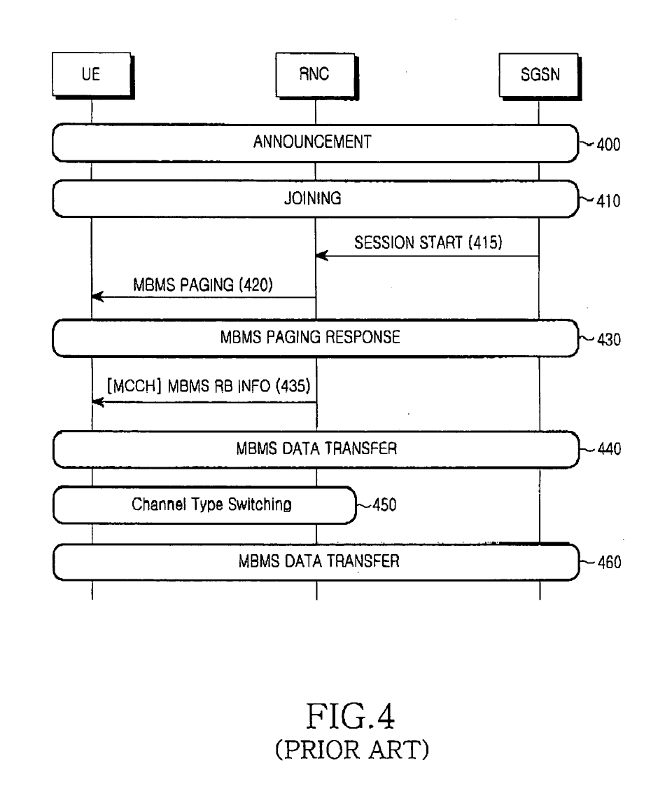

As shown in FIG. 17, at step 1705, a UE performs a service joining procedure with an SGSN. The service joining procedure of step 1705 is similar to the above step 410 of FIG. 4, the above step 1420 of FIG. 14 and the above step 1605 of FIG. 16. Here, the SGSN transmits a message to a CRNC responsible for managing a cell where the UE is located, allowing the CRNC to detect a service request made by the UE. For convenience of explanation, it is assumed in the following description that an SRNC and a CRNC are the same entity.

At step 1710, a CRNC RRC detects that the UE has made a request to join an MBMS service in progress. At step 1715, the CRNC RRC transmits an MBMS radio bearer setup message to a UE RRC. The UE constitutes a PDCP entity, an RLC entity, a MAC entity and a physical layer according to PDCP, RLC, MAC and physical layer configuration information included in the MBMS radio bearer setup message.

At step 1720, the CRNC RRC notifies a CRNC PDCP that the UE has made a request to join the MBMS service in progress. At step 1725, the CRNC PDCP transmits an IR packet to a cell where the requesting UE is located. The UE PDCP receives the IR packet transmitted at step 1725, and initializes its HC context using the received IR packet. Thereafter, the UE PDCP decompresses MBMS data with a compressed header transmitted from the CRNC PDCP.

As described above, the IR packet transmission method according to the embodiment of FIG. 15 transmits HC context information required for header decompression by incorporating the HC context information into the MBMS radio bearer setup message. However, the IR packet transmission method according to the embodiment of FIG. 17 transmits HC context information required for header decompression through a separate RRC message after setting up an MBMS radio bearer.

In the embodiment of FIG. 17, the IR packet required for header decompression is transmitted at intervals of a predetermined period, and if it is determined that IR packet transmission is necessary since a UE has made a request to join the MBMS service, the IR packet is transmitted to the UE even before the predetermined time (corresponding to the predetermined period) to transmit the IR packet.

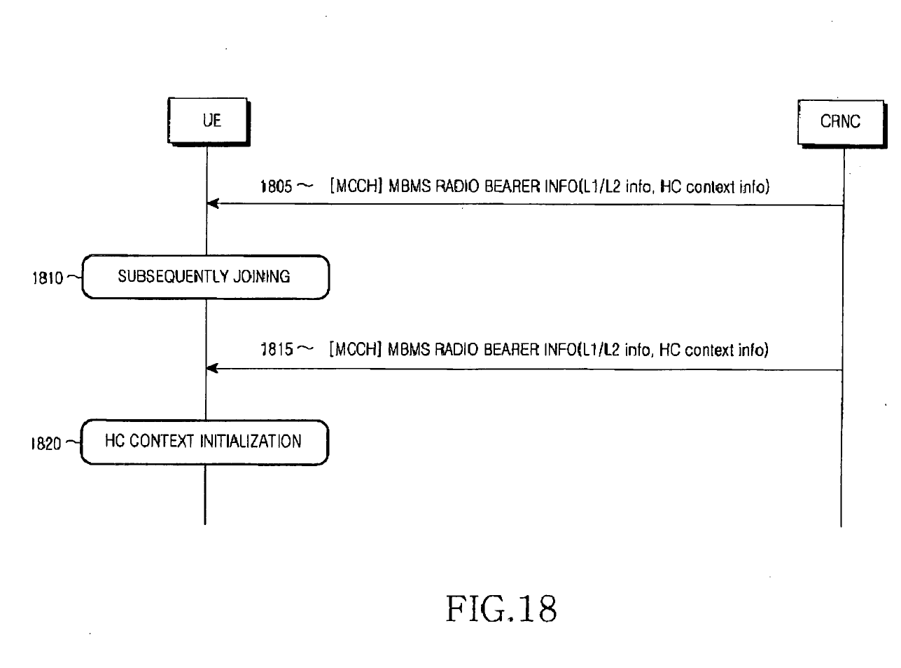

FIG. 18 is a process flow diagram showing yet another embodiment of the IR packet transmission method that is effective against situations as in FIG. 14.

This embodiment proposes periodic transmission of HC context information for UEs that have made a request to join an MBMS service in progress.

As shown in FIG. 18, a CRNC transmits a control message associated with the MBMS service through an MCCH. In this case, to guarantee mobility of the UEs, the CRNC periodically transmits MBMS radio bearer information of the MBMS service being provided on a cell-by-cell basis. The MBMS radio bearer information includes PDCP, RLC and MAC configuration information, etc., for each service.

At step 1805, the CRNC incorporates HC context information into the MBMS radio bearer information to transmit it to the cell, where the UEs requesting the MBMS service are located, through an MCCH.

If a UE requests to join the MBMS service being provided to the cell at step 1810, the UE receives the MBMS radio bearer information transmitted periodically, and accordingly receives the HC context information included in the MBMS radio bearer information at step 1815. The UE receives the MBMS service by receiving the HC context information transmitted periodically through the MCCH.

At step 1820, the UE forms a PDCP entity, an RLC entity, a MAC entity and a physical layer using the MBMS radio bearer information, and initializes its HC context using the HC context information.

The periodic transmission of the HC context information according to this embodiment is effective in guaranteeing the mobility of the UE. If the UE moves from one cell to another, the UE receives the MCCH signal to obtain the configuration information of an MBMS service that the UE desires to receive.

The HC context information is identical for the same service although RTP SNs and RTP TSs may be different. If HC context information has not been received in the current cell with different RTP SNs and different RTP TSs between the previous and current cells, the UE cannot decompress the compressed header. In the embodiment of FIG. 18, the UE in motion can decompress the header by receiving the HC context information transmitted periodically and reading the RTP SN and the RTP TS of the current cell from the received information.

In other words, taking into consideration only the mobility of the UE, the dynamic part (i.e., the RTP SN and TS) of the HC context information, instead of all parts thereof, is created and incorporated into the MBMS radio bearer information to be transmitted through the MCCH.

As apparent from the above description, the present invention provides a method for acquiring a header compression context in a UE to receive an MBMS service, which has the following features and advantages. If the UE has not received HC context information through an IR packet, the UE requests retransmission of the HC context information, and uses HC context information received in response to the request to receive the MBMS service. Accordingly, the UE can efficiently receive the MBMS service. In addition, the HC context information is transmitted through different paths or means according to the number of UEs that have requested retransmission of the HC context information, thereby achieving efficient utilization of radio resources. Further, periodic transmission of the HC context information guarantees the mobility of the UE.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A method for decompressing a header of packet data received by User Equipment (UE) in a mobile communication system providing a packet data service, the method comprising the steps of:
a) receiving, by the UE, packet data including a compressed header from a Radio Network Controller (RNC);
b) determining, by the UE, whether to request retransmission of all or part of header compression context information, based on the received packet data, and transmitting the determined retransmission request from the UE to the RNC; and
c) retransmitting all or part of the header compression context information from the RNC to the UE in response to the determined retransmission request.

2. The method according to claim 1, wherein at step b), the UE transmits the determined retransmission request to the RNC through a Radio Resource Control (RRC) message.

3. The method according to claim 1, wherein at step c), the RNC retransmits all or part of the header compression context information to the UE through an RRC message in response to the determined retransmission request.

4. The method according to claim 1, wherein a Packet Data Convergence Protocol (PDCP) entity in the UE receives the packet data including the compressed header from a PDCP entity in the RNC through a Multicast Traffic Channel (MTCH).

5. The method according to claim 1, further comprising the steps of:
d) decompressing the compressed header of the received packet data, by a PDCP entity in the UE, to determine whether to request retransmission of all or part of the header compression context information; and
e) setting a code identifying the determined retransmission request, by the PDCP entity in the UE, and transmitting the code to an RRC entity in the UE.

6. The method according to claim 5, further comprising the step of:
transmitting the code identifying the determined retransmission request from the RRC entity in the UE to an RRC entity in the RNC through an RRC message.

7. The method according to claim 6, further comprising the step of:
transmitting the code identifying the determined retransmission request from the RRC entity in the RNC to a PDCP entity in the RNC.

8. The method according to claim 7, further comprising the step of:
transmitting all or part of the header compression context information from the PDCP entity in the RNC to the RRC entity in the RNC in response to the code requesting the determined retransmission request.

9. The method according to claim 8, further comprising the step of:
transmitting all or part of the header compression context information from the RRC entity in the RNC to the RRC entity in the UE through an RRC message.

10. The method according to claim 1, further comprising the step of:
transmitting the requested header compression context information from the RNC through a dedicated channel if the number of UEs, which have requested retransmission of the header compression context information, is less than a predetermined number.

11. The method according to claim 1, further comprising the step of:
transmitting the requested header compression context information from the RNC through a common channel if the number of UEs, which have requested retransmission of the header compression context information, is not less than a predetermined number.

12. The method according to claim 1, further comprising the step of:
transmitting all of header compression context information currently used in the RNC if the UE has requested transmission of all of the header compression context information.

13. The method according to claim 1, further comprising the step of:
receiving, by the RNC, header compression context information used for decompressing a header of packet data most recently received by the UE, together with a request for retransmission of the part of the header compression context information, from the UE.

14. The method according to claim 13, further comprising the step of:
transmitting, by the RNC, only a value corresponding to a difference between the header compression context information currently used in the RNC and the header compression context information received from the UE if the UE has requested transmission of part of the header compression context information.

15. A method for decompressing a header of packet data received by a UE in a mobile communication system providing a packet data service, the method comprising the steps of:
a) receiving, by the UE, packet data including a compressed header from an RNC;
b) determining, by the UE, whether to request retransmission of all or part of header compression context information, based on the received packet data, and transmitting the determined retransmission request from the UE to the RNC through an RRC message; and
c) retransmitting said all or part of the header compression context information from the RNC to the UE through a dedicated data channel for packet data transmission in response to the determined retransmission request.

16. A method for decompressing a header of packet data received by a UE in a mobile communication system providing a packet data service, the method comprising the steps of:
a) requesting, by the UE, retransmission of part or all of header compression context information if an error occurs in decompressing the header of the received packet data, depending on a cause of the error; and
b) decompressing, by the UE, a header of the received packet data using header compression context information received in response to the retransmission request.

17. The method according to claim 16, wherein step a) includes the step of setting a code identifying the retransmission of all or part of the header compression context information, and transmitting the set code to an RNC.

18. The method according to claim 16, wherein step a) includes the step of transmitting header compression context information used for decompressing a header of packet data most recently received by the UE, together with a request for retransmission of the part of the header compression context information, from the UE to the RNC.

19. A method for transmitting header compression context information for use in compression of a packet data header from an RNC in a mobile communication system providing a packet data service, the method comprising the steps of:
a) receiving, by the RNC, a request for retransmission of all or part of header compression context information according to a cause of an error occurring in header decompression, said request being received from a UE;
b) checking, by the RNC, whether header compression context information corresponding to the retransmission request received from the UE is stored in the RNC; and
c) determining, by the RNC, whether to transmit all or part of the checked header compression context information according to the retransmission request received from the UE, and transmitting all or part of the header compression context information according to the determination.

20. The method according to claim 19, further comprising the step of:
transmitting the requested header compression context information from the RNC to the UE, which has requested retransmission of the header compression context information, through an RRC message.

21. The method according to claim 19, further comprising the step of:
transmitting the requested header compression context information from the RNC to the UE, which has requested retransmission of the header compression context information, through a data dedicated channel.

22. The method according to claim 19, further comprising the step of:
transmitting all of header compression context information currently used in the RNC from the RNC to the UE if the UE has requested retransmission of all of the header compression context information.

23. The method according to claim 19, wherein step a) includes the step of receiving, by the RNC, header compression context information used for decompressing a header of packet data most recently received by the UE, together with a request for retransmission of part of the header compression context information, from the UE.

24. The method according to claim 19, further comprising the step of:
transmitting, by the RNC, only a value corresponding to difference between the header compression context information currently used in the RNC and the header compression context information received from the UE if the UE has requested transmission of part of the header compression context information.

25. A method for transmitting header compression context information for use in compression of a packet data header to a UE, which has requested a packet data service being provided by a mobile communication system, the method comprising the steps of:
a) checking header compression context information of packet data being provided to a cell where the UE is located; and
b) transmitting the checked header compression context to the UE.

26. The method according to claim 25, wherein step b) includes the step of transmitting the header compression context information to the UE without a request by the UE.

27. The method according to claim 25, further comprising the step of:
transmitting the header compression context information by incorporating the header compression context information into information required to establish a radio channel for transmitting the packet data.

28. The method according to claim 25, further comprising the step of:
transmitting the header compression context information by incorporating the header compression context information into an RRC message after establishing a radio channel for transmitting the packet data.

29. The method according to claim 25, further comprising the step of:
transmitting the header compression context information by incorporating the header compression context information into a control message transmitted periodically for carrying information required to establish a radio channel.

30. The method according to claim 27, wherein the information required to establish the radio channel varies according to characteristics of a cell where the packet data is provided.

31. The method according to claim 29, wherein the information required to establish the radio channel varies according to characteristics of a cell where the packet data is provided.

32. A method for receiving, by a UE, header compression context information for use in compression of a packet data header, said UE having requested a current packet data service being provided by a mobile communication system, the method comprising the steps of:
a) requesting, by the UE, the current packet data service from a Core Network (CN);
b) notifying, by the CN, a Radio Network Controller (RNC) corresponding to a cell, where the UE is located, of the service request by the UE; and
c) checking, by the RNC, header compression context information for packet data being provided to the cell where the UE is located, and transmitting the checked header compression context to the UE by incorporating the checked header compression context into information required to set up a radio bearer.
